(19) United States
(12) Patent Application Publication
(10) Pub. No.: US 2012/0312113 A1
(43) Pub. Date: Dec. 13, 2012

(54) DRIVE FOR A ROTARY DRUM

(76) Inventors: Gerhard Kästingschäfer, Wadersloh (DE); Johannes Auf Dem Venne, Ennigerloh (DE)

(21) Appl. No.: 13/580,510

(22) PCT Filed: Feb. 23, 2011
(86) PCT No.: PCT/EP11/52689

§ 371 Date: Aug. 22, 2012

(30) Foreign Application Priority Data
Mar. 1, 2010 (DE) 10 2010 009 758.6
Sep. 15, 2010 (DE) 10 2010 037 560.8

(51) Int. Cl. F16H 35/06

(52) U.S. Cl. 74/380

(57) ABSTRACT

The drive for a rotary drum according to the invention consists substantially of
a. a ring gear, which can be fastened to the outer circumferential surface of the rotary drum for rotation therewith,
b. a pinion meshing with the ring gear and arranged on a drive shaft for rotation therewith and for tilting movement, the pinion being held with its drive shaft in such a way that it can pivot relative to the ring gear, and
c. a drive motor for driving the drive shaft

In addition to the meshing, the pinion is also in interlocking rolling contact with the ring gear.

The invention relates to a drive for a rotary drum having relatively large dimensions, in particular for a rotary kiln, a cooling drum, a drum mill or the like.

In rotary drums of this type, in particular rotary cement kilns, the drive torque of the drive motor is transmitted to the rotary drum via an intermediate gear (pinion and ring gear). In this case, the housings of the pinion bearing are fastened to the kiln base and the ring gear is mounted on the external circumference of the rotary drum for rotation therewith using a suitable ring gear fastening means.

The loading of the intermediate gear is dependent on the torque required by the oven and on the quality of the meshing between the pinion and ring gear. The true running of the ring gear and the orientation of the pinion relative to the ring gear affect the meshing. For optimum meshing, the shafts of the pinion and ring gear are parallel and the distance is adjusted in such a way that the teeth can roll on one another.

Under greatly variable operating conditions, in particular if the rotary drum is exposed to heat, the kiln shafts are distorted and the distance between the pinion and ring gear is altered. The tumbling and radial run-outs resulting therefrom and the altered axial spacing of the ring gear load the meshing in such a way that overloading of the teeth occurs, and can cause damage. Various technical solutions have therefore already been proposed to make the meshing between the pinion and ring gear independent, or at least substantially independent, of the operating conditions of the rotary drum.

In DE 90 13 226 U1, the use of a tiltable pinion is proposed, as a result of which angular deviations between the shafts of the pinion and ring gear, which are caused by operating conditions, can be substantially compensated. The axial movement of the ring gear (change in length of the rotary drum), which is caused by operating conditions, is accommodated by a sliding movement in the teeth of the pinion and ring gear. However, a radial run-out of the ring gear cannot be compensated merely by a tiltable pinion.

To maintain optimum meshing between the ring gear and pinion, DE 90 13 266 U1 therefore proposes a monitoring device in the ring gear/pinion region, which measures the distance between the pinion and a reference surface on the ring gear. The pinion is also held with the drive shaft thereof in such a way that it can pivot relative to the ring gear. The pinion is adjusted via a control device as a function of the distance measurement in such a way that constant meshing between the ring gear and the pinion is ensured at all times.

Another solution is also known from practical experience, whereby the pinion is rigidly mounted in what is known as a pinion carriage. The pinion carriage is radially and axially guided on the ring gear via rollers. Owing to the guidance of the pinion carriage on the ring gear, the pinion carriage and thus the pinion follow all movements of the ring gear. The connection between the pinion carriage and ring gear is interlocking.

The pinion carriage is also supported on the base of the kiln. The support bracket holds the pinion carriage in a position tangential to the ring gear and comprises two joints, which allow the pinion carriage to follow the tumbling and radial run-out and the axial displacement of the ring gear without constraints. The rotational connection between the pinion and the main gear, which is fixed to the kiln base, is however disadvantageous in this embodiment. In order to compensate the relative movements between the pinion carriage and the main gear, the torque is transmitted from the main gear to the pinion carriage using a universal-joint shaft (cardan shaft). This universal-joint shaft can readjust an offset angle and the change in length between the main gear and the pinion carriage. It is however arranged on the high-torque side of the main gear, in such a way that the joints are exposed to correspondingly high stresses. The considerable forces which result from the linear extension lead to the pinion no longer being able to follow the movements of the ring gear without the use of force. In order to reduce this problem, it has been proposed to use the teeth of the gear in the pinion carriage to readjust the length. The problem is indeed reduced as a result, but not solved. The rotational connection (cardan shaft) on the high-torque side of the main gear still remains problematic. In addition, this technical solution is complex and up to 40% more expensive than a conventional drive having a rigidly mounted pinion.

U.S. Pat. No. 4,234,237 A, U.S. Pat. No. 2,908,179 A, CH 231 753 A and DE 697 258 also disclose a further drive concept, in which the pinion body serves to drive and also to support the drum to be driven. This drive concept is, however, unable to compensate tumbling run-outs of the drum caused by production and operation.

The object of the invention is therefore to find a new solution, with which both the tumbling run-out and the radial run-out of the ring gear can be reliably absorbed.

According to the invention, this object is achieved by the features of claim 1.

The drive for a rotary drum according to the invention consists substantially of
a. a ring gear, which can be fastened to the outer circumferential surface of the rotary drum for rotation therewith,
b. a pinion meshing with the ring gear and arranged on a drive shaft for rotation therewith and for tilting movement, the pinion with its drive shaft being held pivotally relative to the ring gear, and
c. a drive motor for driving the drive shaft.
   In addition to the meshing, the pinion is also in interlocking rolling contact with the ring gear.

The tiltable pinion allows the tumbling run-out of the ring gear to be compensated. An axial movement of the ring gear can be accommodated by a sliding movement in the teeth of the pinion and ring gear, or by a sliding movement of the pinion in the bearings of the drive shaft. In this case, the pinion is guided through the ring gear in an axial direction.

Owing to the additional, interlocking rolling contact of the pinion with the ring gear, any radial run-out of the ring gear can also be compensated.

The dependent claims relate to further configurations of the invention.

According to a preferred configuration of the invention, in order to produce interlocking rolling contact, cylindrical rolling paths are formed on both sides of the ring gear, concentric to the ring gear, and the pinion comprises two cylindrical contact surfaces, formed concentric to the drive shaft, each contact surface of the pinion being in rolling contact with a rolling path of the ring gear.

The interlocking rolling contact ensures a constant meshing between the pinion and the ring gear at all times, since the pinion follows any radial run-out of the ring gear by means of the interlocking rolling contact.

The contact surfaces of the pinion preferably have a diameter which corresponds to the diameter of the pitch circle. To this effect, the rolling paths of the ring gear have a diameter which corresponds to the pitch circle of the ring gear. In this manner, it is achieved that the rolling paths roll on one another without slipping.

The contact surfaces can, be formed for example, on the pinion by rotationally symmetrical shoulders. In the same manner, the rolling paths can also be formed on the ring gear by rotationally symmetrical shoulders. The shoulders on the pinion and ring gear can be produced by a corresponding formation of the pinion/ring gear, or by additional components, in particular concentric rings, which are fastened to the pinion/ring gear.

The tiltable pinion preferably comprises an internal pinion body and an external pinion body, which are coupled to each other to transmit the rotational movement of the drive shaft via curved teeth, the external pinion body comprising teeth which engage the ring gear.

According to a further configuration of the invention, a concentric and rotatably mounted ring is provided between the pinion and the ring gear so as to produce the interlocking rolling contact.

The pinion can be displaceable in an axial direction in bearings of the drive shaft and/or is guided through the ring gear in an axial direction.

The drive shaft is expediently coupled directly to a main gear. It can also be provided for the drive motor to be connected to the main gear via a universal-joint shaft, a torque bracket provided on the main gear and the universal-joint shaft being able to accommodate an axial movement of the drive shaft.

The universal-joint shaft connected to the main gear can be arranged in the direction of the drive shaft or at an angle thereto.

Owing to the optimum meshing, it is possible according to a further configuration of the invention to use a ring gear and a pinion having hardened tooth profiles, as a result of which the intermediate gear can be thinner and thus less expensive in construction.

Further advantages and configurations of the invention will be described in greater detail on the basis of the description of some embodiments, and the drawings, in which:

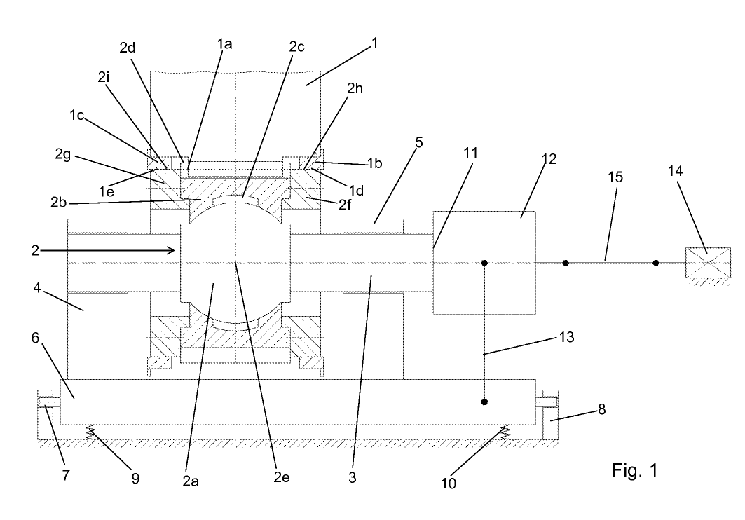

FIG. 1 is a partial sectional view of the drive according to a first embodiment,

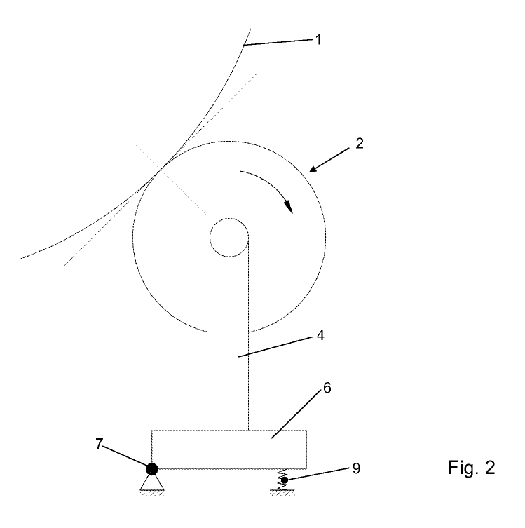

FIG. 2 is a side view of the drive according to FIG. 1,

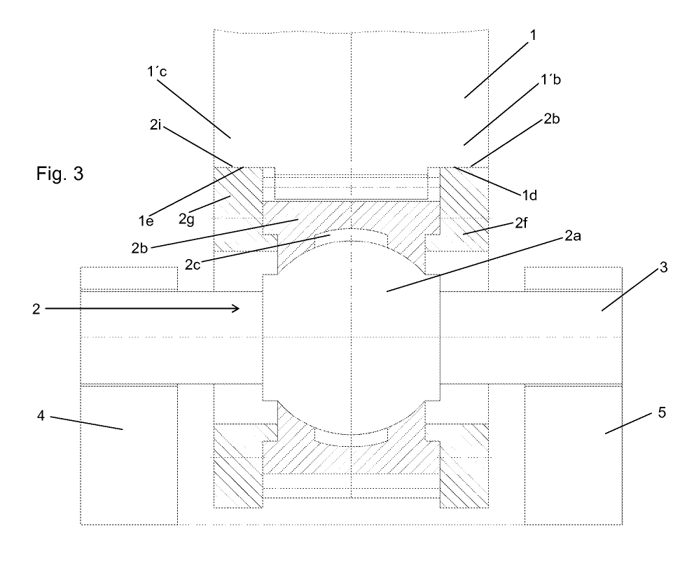

FIG. 3 is a partial sectional view of the drive according to a second embodiment,

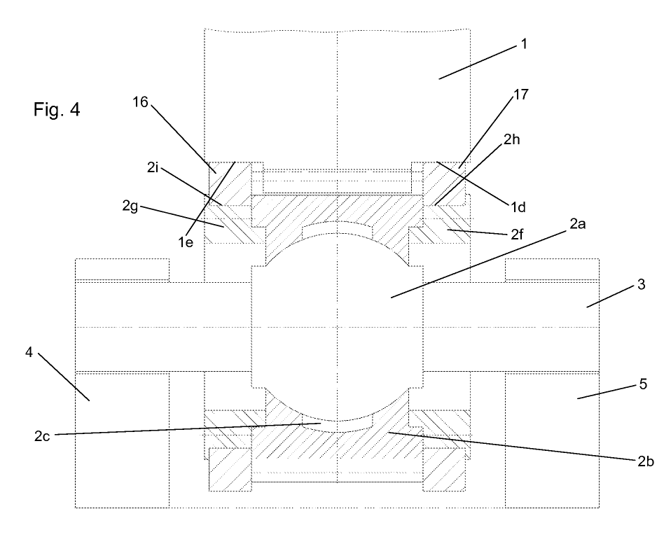

FIG. 4 is a partial sectional view of the drive according to a third embodiment.

FIGS. 1 and 2 show a drive for a rotary drum, in particular for a rotary kiln for producing cement. It consists substantially of a ring gear 1, which can be fastened to the outer circumferential surface of a rotary drum (not shown in detail) for rotation therewith, and a pinion 2 which meshes with the ring gear 1 and is arranged on a drive shaft 3 for rotation therewith and for tilting movement. The drive shaft 3 is mounted on both sides of the pinion 2 in bearings 4, 5, which in turn are mounted on a base frame 6.

The pinion is preferably displaceable in an axial direction in the bearings 4, 5 of the drive shaft 3. The pinion 2 can also be guided through the ring gear 1 in an axial direction.

The tiltable pinion 2 comprises an internal pinion body 2a and an external pinion body 2b, which are coupled to each other via curved teeth 2c to transmit the rotation of the drive shaft 3. The external pinion body 2b also comprises teeth 2d which mesh with the ring gear. The internal pinion body 2a has a surface in the form of a segment of a sphere, on which the external pinion body 2b is spherically mounted. The transmission of the torque from the internal pinion body 2a, which is connected to the drive shaft 3 for rotation therewith, to the external pinion body 2b takes place via the curved teeth 2c.

Owing to the spherical mounting and the curved teeth, the external pinion body 2b has two degrees of rotational freedom about the centre 2e of the spherical mounting. Between the teeth 2d of the pinion 2 and the teeth 1a of the ring gear which cooperate therewith, there is a non-positive meshing. The external pinion body 2b follows any tumbling run-out of the ring gear 1 if the unequal load distribution across the width of the teeth overcomes the friction forces in the spherical mounting and the curved teeth 2c.

Any radial run-out of the ring gear 1 is compensated by an interlocking rolling contact of the pinion 2 with the ring gear 1. For this purpose, two rotationally symmetrical shoulders 1b, 1c are fastened to the ring gear 1, which shoulders each comprise a cylindrical rolling path 1d, 1e. Corresponding rotationally symmetrical shoulders 2f, 2g which have cylindrical contact surfaces 2h, 2i are attached to the pinion 2, in particular to the external pinion body 2b, in a corresponding manner, each contact surface 2h and 2i being in rolling contact with a rolling path 1d and 1e, respectively. The contact surfaces 2h, 2i of the pinion 2 have a diameter which corresponds to the diameter of the pitch circle of the teeth 2d of the pinion 2. In a corresponding manner, the rolling paths 1d, 1e of the ring gear 1 have a diameter which corresponds to the diameter of the pitch circle of the teeth 1a of the ring gear 1.

In order to achieve the rolling contact between the ring gear 1 and the pinion, the base frame 6 is held pivotally in bearings 7, 8. In this case, spring elements 9, 10 ensure that even when the drive is stationary, contact between the contact surfaces of the pinion 2 and the rolling paths of the ring gear 1 is maintained. The contact surfaces 2h, 2i are pressed by the circumferential force (drive force) of the teeth and by the additional spring elements 9, 10 onto the associated rolling paths of the ring gear 1. Using this relatively easy construction, the pinion 2 can directly follow any radial run-out of the ring gear, in such a way that an optimum engagement between the ring gear and the pinion is ensured at all times. In this manner, overloading of the teeth and any damage thereto is reliably prevented.

The drive shaft 3 is connected via an interface 11 to the main gear 12 in such a way that the main gear 12 and the drive shaft 3 follow any pivot movement of the base frame 6. A torque bracket 13 (indicated schematically) is provided between the main gear 12 and the base frame 6.

The interface is expediently designed in such a way that intermediate gears and main gears from different manufacturers or suppliers can be used. A drive motor 14, arranged so as to be fixed, is connected via a universal-joint shaft 15 to the main gear 12, the universal-joint shaft 15 connected to the main gear 12 being able to be arranged in the direction of the drive shaft (as shown) or at an angle thereto. Owing to this construction, the main gear 12 on the high-torque side is directly coupled via the interface, that is to say without an additional universal-joint shaft, to the drive shaft 3. The torque bracket 13 provided on the main gear 12 and the universal-joint shaft 15 can expediently accommodate an axial movement of the drive shaft 3.

In the embodiment according to FIG. 1, the rotationally symmetrical shoulders 1b, 1c are formed by concentric rings, which are fastened to the ring gear 1. FIG. 3 shows a drive according to a second embodiment, which differs from the first embodiment substantially only in that the shoulders 1′b and 1′c are formed integrally with the ring gear 1.

A further possibility consists in the provision of a ring 16 and 17, which is formed concentrically around the drive shaft 3 and rotatably mounted, between the rolling path 1e and the contact surface 2i and the rolling path 1d and the contact surface 2h (see FIG. 4). The two rings are in this case axially secured by being arranged between the external pinion body 2b and the shoulders 2g and 2f. The rings 16, 17 can execute a relative movement relative to the contact surfaces 2h, 2i of the supports 2f and 2g via a clearance fit.

In the above-described drive, simple, proven and cost-effective construction elements can be used. The rolling contact between the pinion and the ring gear also results in optimum meshing, irrespective of the operating state. Owing to the direct coupling of the main gear 12 to the drive shaft 3, interposed universal-joint shafts which are susceptible to damage can also be dispensed with on the high-torque side.

1. Drive for a rotary drum comprising
a. a ring gear adapted to be fastened to the outer circumferential surface of the rotary drum for rotation therewith,
b. a pinion meshing with the ring gear and arranged on a drive shaft for rotation therewith and for tilting movement, the pinion being held by the drive shaft such that it can pivot relative to the ring gear, and
c. a drive motor for driving the drive shaft
characterised in that, in addition to meshing with the ring gear, the pinion is also in interlocking rolling contact with the ring gear.

2. Drive according to claim 1, characterised in that in order to produce interlocking rolling contact, cylindrical rolling paths are formed on both sides of the ring gear, concentric to the ring gear, and the pinion comprises two cylindrical contact surfaces, formed concentric to the drive shaft, each contact surface of the pinion being in rolling contact with a rolling path of the ring gear.

3. Drive according to claim 2, characterised in that the contact surfaces of the pinion have a diameter which corresponds to the diameter of the pitch circle of the pinion.

4. Drive according to either claim 2, characterised in that the rolling paths of the ring gear have a diameter which corresponds to the diameter of the pitch circle of the ring gear.

5. Drive according to claim 2, characterised in that the contact surfaces are formed on the pinion by rotationally symmetrical shoulders.

6. Drive according to claim 2, characterised in that the rolling paths are formed on the ring gear by rotationally symmetrical shoulders.

7. Drive according to claim 1, characterised in that the pinion comprises an internal pinion body and an external pinion body, which are coupled to each other via curved teeth to transmit the rotation of the drive shaft and the external pinion body comprises teeth which engage the ring gear.

8. Drive according to claim 7, characterised in that the external pinion body is mounted spherically on the internal pinion body.

9. Drive according to claim 1, characterised in that the pinion and the ring gear are displaceable relative to each other in an axial direction.

10. Drive according to claim 1, characterised in that at least one concentric and rotatably mounted ring is provided between the pinion and the ring gear so as to produce the interlocking rolling contact.

11. Drive according to claim 1, characterised in that the drive shaft is directly coupled to a main gear.

12. Drive according to claim 1, characterised in that the pinion is displaceable in an axial direction in bearings of the drive shaft.

13. Drive according to claim 1, characterised in that the pinion is guided through the ring gear in an axial direction.

14. Drive according to claim 1, characterised in that the drive motor is connected via a universal-joint shaft to the main gear, wherein a torque bracket provided on the main gear and the universal-joint shaft accommodate an axial movement of the drive shaft.

15. Drive according to claim 1, characterised in that the ring gear and the pinion have hardened tooth profiles.
